(19) United States
(12) Patent Application Publication
(10) Pub. No.: US 2023/0333826 A1
(43) Pub. Date: Oct. 19, 2023

(54) FAST FPGA COMPILATION THROUGH BITSTREAM STITCHING

(71) Applicants: Michael Kinsner, Halifax (CA); Byron Sinclair, Toronto (CA); Deshanand P. Singh, Toronto (CA); Scott Jeremy Weber, Piedmont, CA (US); Mahesh A. Iyer, Fremont, CA (US); Chengping Liang, Toronto (CA); Victor Tzi-on Zhang, Toronto (CA); Gabriel Quan, Toronto (CA)

(72) Inventors: Michael Kinsner, Halifax (CA); Byron Sinclair, Toronto (CA); Deshanand P. Singh, Toronto (CA); Scott Jeremy Weber, Piedmont, CA (US); Mahesh A. Iyer, Fremont, CA (US); Chengping Liang, Toronto (CA); Victor Tzi-on Zhang, Toronto (CA); Gabriel Quan, Toronto (CA)

(21) Appl. No.: 18/338,236

(22) Filed: Jun. 20, 2023

(51) Int. Cl. G06F 8/41; G06F 8/36

(52) U.S. Cl. CPC G06F 8/41; G06F 8/36

(57) ABSTRACT

Systems or methods of the present disclosure may provide a library including multiple regional bits streams that may be pre-generated by a manufacturer and/or custom generated by a designer that may be used to implement a design onto an integrated circuit device. The design may be decomposed into one or more regional bitstreams and stitched to form a larger combined bitstream to be implemented as coarse-grained operations on the integrated circuit device, thereby decreasing compilation time experienced by the designer. The combined bitstreams may be loaded into all or a portion of the integrated circuit device to realize the design. Additionally or alternatively, the integrated circuit device may include a hardened networks-on-chip to improve data routing within the combined bitstream.

### BACKGROUND

The present invention relates generally to programmable logic devices. More particularly, the present disclosure relates to reducing compilation time for programmable logic devices, such as high-capacity field programmable gate arrays (FPGAs).

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Programmable logic devices, a class of integrated circuits, may be programmed to perform a wide variety of operations. The long compilation time may hinder market traction, particularly with design entry methods such as high-level design (HLD) including C++ based design entry. For example, the long compilation time may increase both development costs and development time, and uncertainty in time to reach market with the designs. Indeed, as programmable logic devices increase in complexity and/or increase in size, the compilation time for programmable logic devices may become even more computationally intensive, resource intensive, and cost intensive due to the increasing number of fine-grained elements.

### BRIEF DESCRIPTION OF THE DRAWINGS

Various aspects of this disclosure may be better understood upon reading the following detailed description and upon reference to the drawings in which:

FIG. 1 is a block diagram of a system used to program an integrated circuit device, in accordance with an embodiment of the present disclosure;

FIG. 2 is a block diagram of the integrated circuit device of FIG. 1, in accordance with an embodiment of the present disclosure;

FIG. 3 is a block diagram of programmable fabric of the integrated circuit device of FIG. 1, in accordance with an embodiment of the present disclosure;

FIG. 4 is a schematic illustration of a design being decomposed into a data flow graph, mapped to a library, and stitched into a combined bitstream, in accordance with an embodiment of the present disclosure;

FIG. 5 is a block diagram of a portion of the integrated circuit device of FIG. 1 including regions coupled by an interposer, in accordance with an embodiment of the present disclosure;

FIG. 6 is a block diagram of a portion of the integrated circuit device of FIG. 1 including regions coupled by nodes, in accordance with an embodiment of the present disclosure;

FIG. 7 is a block diagram of a portion of the integrated circuit device of FIG. 1 including regions coupled by nodes and the interposer, in accordance with an embodiment of the present disclosure;

FIG. 8 is a block diagram of a portion of the integrated circuit device of FIG. 1 implementing a design using a combined bitstream and a network-on-chip, in accordance with an embodiment of the present disclosure;

FIG. 9 is a block diagram of a portion of the integrated circuit device of FIG. 1 implementing a design by bitstream stitching multiple regions and the network-on-chip, in accordance with an embodiment of the present disclosure;

FIG. 10 is flowchart of a method for implementing a design into the integrated circuit device of FIG. 1 using bitstream stitching, in accordance with an embodiment of the present disclosure;

FIG. 11 is a flowchart of a method for configuring the integrated circuit device of FIG. 1 using a combined bitstream, in accordance with an embodiment of the present disclosure; and

FIG. 12 is a block diagram of a data processing system, in accordance with an embodiment of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

The present disclosure describes systems and techniques related to implementing a design using coarse-grained operations onto integrated circuitry, such as high-capacity field programmable gate arrays (FPGAs), to decrease compilation time. In particular, the embodiments described herein are directed to stitching two or more pre-compiled bitstreams (e.g., pre-compiled primitive bitstream, pre-compiled regional bitstream, pre-compiled configuration bitstream) to form a combined bitstream for implementing the design. For example, programmable logic devices, a class of integrated circuit devices, may be programmable to realize different high-level designs (HLD). Coarse-grained operations may be implemented rather than fine-grained operations to reduce compilation time used to perform stitching of the operations and/or to increase storage efficiency by limiting an amount of different stored operations.

Prior to compilation of the design, one or more regional bitstreams may be generated, compiled, and stored in a library. The regional bitstreams may include common IP library components, constant values, operators, commonly used operations, commonly used functionalities, and the like. The regional bitstreams may be pre-compiled based on a location, an operation, a data type, and the like. Additionally, a designer and/or a processor (e.g., compiler) may add one or more custom bitstreams to the library. The custom bitstreams may include specialized (e.g., non-standardized) operations. Additionally or alternatively, the processor (e.g., compiler) may receive a design and determine that a portion of the design or all of the design may not be mapped to the regional bitstreams stored in the library. As such, the processor, via design software running on the processor, may generate the custom bitstream based on the design and store the custom bitstream in the library for subsequent configurations, which reduces subsequent compilation time.

To implement the design on the integrated circuit, the processor, via the design software running on the processor, may decompose the design into one or more graph nodes and map them to one or more regional bitstreams in the library. For example, the processor may map the graph nodes to two or more regional bitstreams and stitch (e.g., assemble) the two or more regional bitstreams into a combined bitstream. The processor may configure a portion of the integrated circuit device using the combined bitstream. Additionally or alternatively, the processor may stitch together the two or more regional bitstreams to generate a combined bitstream for configuring the entire integrated circuit device. By pre-compiling and stitching the regional bitstreams, the design may be implemented as a coarse-grained operation, which reduces compilation time. For example, the compilation time using the pre-compilation of at least a portion of the bitstream may be seconds, minutes, hours, or shorter than a compilation that does not use pre-compilation of the bitstream.

Further, implementing the combined bitstream on the integrated circuit device may be simplified using network-on-chips (NOCs). For example, a first regional bitstream may be stitched to a first access point of the NOC and a second regional bitstream may be stitched to a second access point of the NOC. The NOC may provide a high data transport rate between the first regional bitstream and the second regional bitstream while providing for spatial decoupling of the combined bitstream. The NOC may also provide data transport between the combined bitstream and a memory, which may improve operating efficiency of the integrated circuit device.

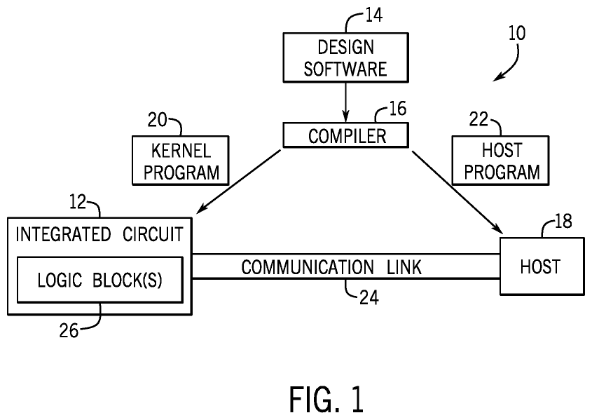

With the foregoing in mind, FIG. 1 illustrates a block diagram of a system 10 that may implement one or more functionalities. For example, a designer may desire to implement functionality, such as the operations of this disclosure, on an integrated circuit device 12 (e.g., a programmable logic device, such as a field programmable gate array (FPGA) or an application specific integrated circuit (ASIC)). In some cases, the designer may specify a high-level program to be implemented, such as an OpenCL® program or SYCL, which may enable the designer to more efficiently and easily provide programming instructions to configure a set of programmable logic cells for the integrated circuit device 12 without specific knowledge of low-level hardware description languages (e.g., Verilog or VHDL). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

The designer may implement high-level designs using design software 14, such as a version of INTEL® QUARTUS® by INTEL CORPORATION. The design software 14 may use a compiler 16 to convert the high-level program into a lower-level description. In some embodiments, the compiler 16 and the design software 14 may be packaged into a single software application. The compiler 16 may provide machine-readable instructions representative of the high-level program to a host 18 and the integrated circuit device 12. The host 18 may receive a host program 22 which may be implemented by the kernel programs 20. To implement the host program 22, the host 18 may communicate instructions from the host program 22 to the integrated circuit device 12 via a communications link 24, which may be, for example, direct memory access (DMA) communications or peripheral component interconnect express (PCIe) communications. In some embodiments, the kernel programs 20 and the host 18 may enable configuration of a logic block 26 on the integrated circuit device 12. The logic block 26 may include circuitry and/or other logic elements and may be configured to implement arithmetic operations, such as addition and multiplication.

The designer may use the design software 14 to generate and/or to specify a low-level program, such as the low-level hardware description languages described above. For example, the design software 14 may be used to map a workload to one or more routing resources of the integrated circuit device 12 based on a timing, a wire usage, a logic utilization, and/or a routability. Additionally or alternatively, the design software 14 may be used to route first data to a portion of the integrated circuit device 12 and route second data, power, and clock signals to a second portion of the integrated circuit device 12. Further, in some embodiments, the system 10 may be implemented without a host program 22 and/or without a separate host program 22. Moreover, in some embodiments, the techniques described herein may be implemented in circuitry as a non-programmable circuit design. Thus, embodiments described herein are intended to be illustrative and not limiting.

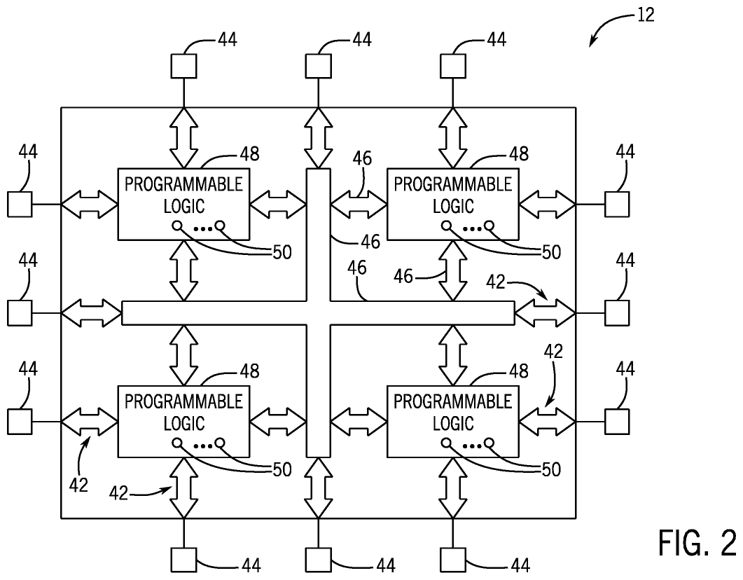

Turning now to a more detailed discussion of the integrated circuit device 12, FIG. 2 is a block diagram of an example of the integrated circuit device 12 as a programmable logic device, such as a field-programmable gate array (FPGA). Further, it should be understood that the integrated circuit device 12 may be any other suitable type of programmable logic device (e.g., a structured ASIC such as eASIC™ by Intel Corporation ASIC and/or application-specific standard product). The integrated circuit device 12 may have input/output circuitry 42 for driving signals off device and for receiving signals from other devices via input/output pins 44. Interconnection resources 46, such as global and local vertical and horizontal conductive lines and buses, and/or configuration resources (e.g., hardwired couplings, logical couplings not implemented by user logic), may be used to route signals on integrated circuit device 12. Additionally, interconnection resources 46 may include fixed interconnects (conductive lines) and programmable interconnects (i.e., programmable connections between respective fixed interconnects). For example, the interconnection resources 46 may be used to route signals, such as clock or data signals, through the integrated circuit device 12. Additionally or alternatively, the interconnection resources 46 may be used to route power (e.g., voltage) through the integrated circuit device 12. Programmable logic 48 may include combinational and sequential logic circuitry. For example, programmable logic 48 may include look-up tables, registers, and multiplexers. In various embodiments, the programmable logic 48 may be configured to perform a custom logic function. The programmable interconnects associated with interconnection resources may be considered to be a part of programmable logic 48.

Programmable logic devices, such as the integrated circuit device 12, may include programmable elements 50 with the programmable logic 48. In some embodiments, at least some of the programmable elements 50 may be grouped into logic array blocks (LABs). As discussed above, a designer (e.g., a customer) may (re)program (e.g., (re)configure) the programmable logic 48 to perform one or more desired functions. By way of example, some programmable logic devices may be programmed or reprogrammed by configuring programmable elements 50 using mask programming arrangements, which is performed during semiconductor manufacturing. Other programmable logic devices are configured after semiconductor fabrication operations have been completed, such as by using electrical programming or laser programming to program the programmable elements 50. In general, programmable elements 50 may be based on any suitable programmable technology, such as fuses, antifuses, electrically programmable read-only-memory technology, random-access memory cells, mask-programmed elements, and so forth.

Many programmable logic devices are electrically programmed. With electrical programming arrangements, the programmable elements 50 may be formed from one or more memory cells. For example, during programming, configuration data is loaded into the memory cells using input/output pins 44 and input/output circuitry 42. In one embodiment, the memory cells may be implemented as random-access-memory (RAM) cells. The use of memory cells based on RAM technology as described herein is intended to be only one example. Further, since these RAM cells are loaded with configuration data during programming, they are sometimes referred to as configuration RAM cells (CRAM). These memory cells may each provide a corresponding static control output signal that controls the state of an associated logic component in programmable logic 48. In some embodiments, the output signals may be applied to the gates of metal-oxide-semiconductor (MOS) transistors within the programmable logic 48.

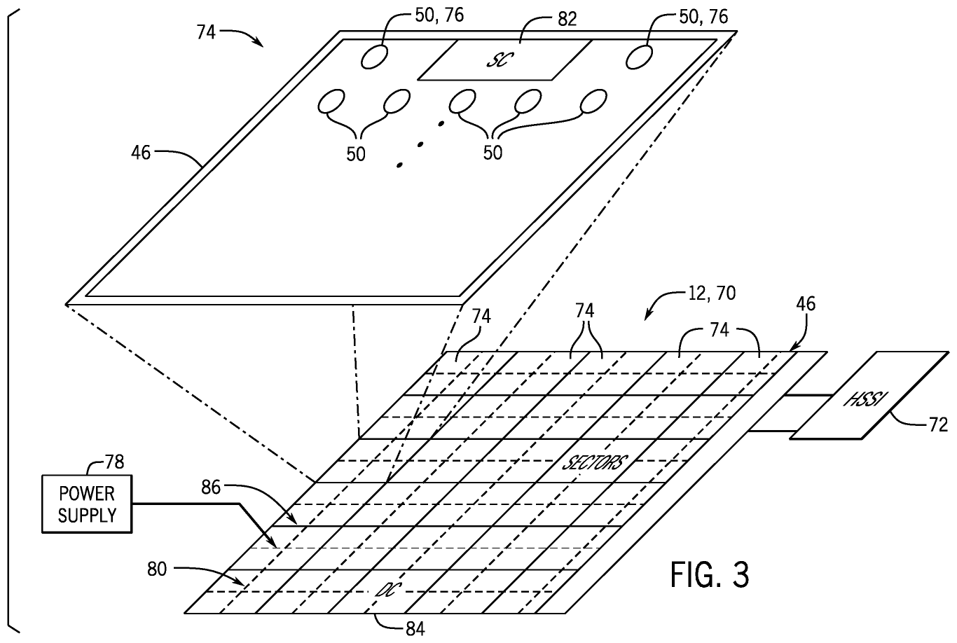

The integrated circuit device 12 may include any programmable logic device such as a field programmable gate array (FPGA) 70, as shown in FIG. 3. For the purposes of this example, the FPGA 70 is referred to as a FPGA, though it should be understood that the device may be any suitable type of programmable logic device (e.g., an application-specific integrated circuit and/or application-specific standard product). In one example, the FPGA 70 is a sectorized FPGA of the type described in U.S. Patent Publication No. 2016/0049941, “Programmable Circuit Having Multiple Sectors,” which is incorporated by reference in its entirety for all purposes. The FPGA 70 may be formed on a single plane. Additionally or alternatively, the FPGA 70 may be a three-dimensional FPGA having a base die and a fabric die of the type described in U.S. Pat. No. 10,833,679, “Multi-Purpose Interface for Configuration Data and User Fabric Data,” which is incorporated by reference in its entirety for all purposes.

In the example of FIG. 3, the FPGA 70 may include transceiver 72 that may include and/or use input/output circuitry, such as input/output circuitry 42 in FIG. 2, for driving signals off the FPGA 70 and for receiving signals from other devices. Interconnection resources 46 may be used to route signals, such as clock or data signals, through the FPGA 70. The FPGA 70 is sectorized, meaning that programmable logic resources may be distributed through a number of discrete programmable logic sectors 74. Programmable logic sectors 74 may include a number of programmable elements 50 having operations defined by configuration memory 76 (e.g., CRAM). A power supply 78 may provide a source of voltage (e.g., supply voltage) and current to a power distribution network (PDN) 80 that distributes electrical power to the various components of the FPGA 70. Operating the circuitry of the FPGA 70 causes power to be drawn from the power distribution network 80.

There may be any suitable number of programmable logic sectors 74 on the FPGA 70. Indeed, while 29 programmable logic sectors 74 are shown here, it should be appreciated that more or fewer may appear in an actual implementation (e.g., in some cases, on the order of 50, 100, 500, 1000, 5000, 10,000, 50,000 or 100,000 sectors or more). Programmable logic sectors 74 may include a sector controller (SC) 82 that controls operation of the programmable logic sector 74. Sector controllers 82 may be in communication with a device controller (DC) 84.

Sector controllers 82 may accept commands and data from the device controller 84 and may read data from and write data into its configuration memory 76 based on control signals from the device controller 84. In addition to these operations, the sector controller 82 may be augmented with numerous additional capabilities. For example, such capabilities may include locally sequencing reads and writes to implement error detection and correction on the configuration memory 76 and sequencing test control signals to effect various test modes.

The sector controllers 82 and the device controller 84 may be implemented as state machines and/or processors. For example, operations of the sector controllers 82 or the device controller 84 may be implemented as a separate routine in a memory containing a control program. This control program memory may be fixed in a read-only memory (ROM) or stored in a writable memory, such as random-access memory (RAM). The ROM may have a size larger than would be used to store only one copy of each routine. This may allow routines to have multiple variants depending on “modes” the local controller may be placed into. When the control program memory is implemented as RAM, the RAM may be written with new routines to implement new operations and functionality into the programmable logic sectors 74. This may provide usable extensibility in an efficient and easily understood way. This may be useful because new commands could bring about large amounts of local activity within the sector at the expense of only a small amount of communication between the device controller 84 and the sector controllers 82.

Sector controllers 82 thus may communicate with the device controller 84, which may coordinate the operations of the sector controllers 82 and convey commands initiated from outside the FPGA 70. To support this communication, the interconnection resources 46 may act as a network between the device controller 84 and sector controllers 82. The interconnection resources 46 may support a wide variety of signals between the device controller 84 and sector controllers 82. In one example, these signals may be transmitted as communication packets.

The use of configuration memory 76 based on RAM technology as described herein is intended to be only one example. Moreover, configuration memory 76 may be distributed (e.g., as RAM cells) throughout the various programmable logic sectors 74 of the FPGA 70. The configuration memory 76 may provide a corresponding static control output signal that controls the state of an associated programmable element 50 or programmable component of the interconnection resources 46. The output signals of the configuration memory 76 may be applied to the gates of metal-oxide-semiconductor (MOS) transistors that control the states of the programmable elements 50 or programmable components of the interconnection resources 46.

The programmable elements 50 of the FPGA 40 may also include some signal metals (e.g., communication wires) to transfer a signal. In an embodiment, the programmable logic sectors 74 may be provided in the form of vertical routing channels (e.g., interconnects formed along a y-axis of the FPGA 70) and horizontal routing channels (e.g., interconnects formed along an x-axis of the FPGA 70), and each routing channel may include at least one track to route at least one communication wire. If desired, communication wires may be shorter than the entire length of the routing channel. That is, the communication wire may be shorter than the first die area or the second die area. A length L wire may span L routing channels. As such, a length of four wires in a horizontal routing channel may be referred to as “H4” wires, whereas a length of four wires in a vertical routing channel may be referred to as “V4” wires.

As discussed above, some embodiments of the programmable logic fabric may be configured using indirect configuration techniques. For example, an external host device may communicate configuration data packets to configuration management hardware of the FPGA 70. The data packets may be communicated internally using data paths and specific firmware, which are generally customized for communicating the configuration data packets and may be based on particular host device drivers (e.g., for compatibility). Customization may further be associated with specific device tape outs, often resulting in high costs for the specific tape outs and/or reduced scalability of the FPGA 70.

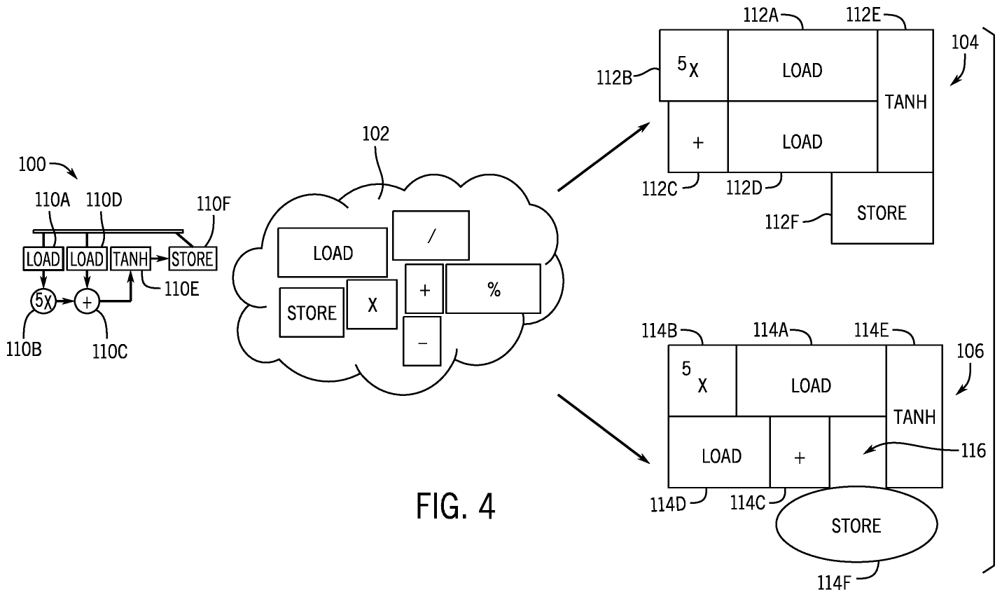

With the foregoing in mind, FIG. 4 is a schematic illustration of a design from a high-level program being decomposed into a data flow graph 100, mapped to a library 102 of regional bitstreams, and stitched into a combined bitstream (e.g., combined bitstream 104 and combined bitstream 106). For example, a user may create the design using high-level programs, such as C++, Simulink/digital signal processing (DSP) Builder, Python, register transfer level (RTL) design entries (e.g., Verilog, VHDL), or the like. The design may include a set of data types and operations on those data types. The design may be decomposed into the data flow graph 100 with any suitable number of graph nodes 110 (individually referred to as graph nodes 110A, 110B, 110C, 110D, 110E, and 110F) to realize the design on the integrated circuit device 12.

To this end, the design software 14 may include a tool to convert the high-level design into a lower-level description. The tool may be stored as instructions in a non-transitory medium (e.g., memory) and may be executed by a processor when executing the design software. For example, the tool (e.g., compiler 16) may decompose the design by defining a bounded set of primitive operators, a standard data type and width, a memory access mode and/or memory models, one or more control flow graphs, one or more personas, and the like. The tool may generate a data flow graph 100 based on the design that includes graph nodes 110. The graph nodes 110 represent constant values, data types, operators, functionality blocks, operational blocks, and the like. As illustrated, the data flow graph 100 is an operation including five multiplied by data loaded from the memory, added to additional data loaded from the memory, input into a hyperbolic tangent function, and the result may be stored back to the memory but may include any combination of elements to form an operation. To this end, the data flow graph 100 may include a first graph node 110A including a functionality, a second graph node 110B including a constant value and an operator, a third graph node 110C including an operator, a fourth graph node 110D including a functionality, a fifth graph node 110E including a functionality, and a sixth graph node 110F including a functionality. In an embodiment, the first graph node 110A may be two individual graph nodes, such as a graph node including and/or loading the constant value and a graph node including the operator.

Each of the graph nodes 110 may be mapped to one or more regional bitstreams stored in the library 102. For example, one graph node 110 may be mapped to one Regional bitstream (e.g., 1:1 mapping), two or more regional bitstreams (e.g., 1:many mapping), or a portion of a regional bitstream (e.g., many:1 mapping). The regional bitstreams may be loaded to the library 102 by a manufacturer loaded prior to shipping the integrated circuit device 12 and/or be loaded to the library 102 by the user. For example, the user may store custom regional bitstreams. Additionally or alternatively, the user may load a design and the tool may generate the custom regional bitstream based on the design.

The regional bitstreams may be pre-compiled to reduce user-experienced compilation time. As used herein, “pre-compiled” means the compilation of the bitstream prior to compilation of other portions of the design. As such, pre-compilation of the design uses coarse-grained operations compiled before a user compile time during which the other portions of the design are compiled and that decreases an amount of user time for compilation. The regional bitstreams may include operations, functionalities, operators, numbers, data types, constant values, and the like. The regional bitstreams may be uniform in size or may include differing sizes and geometries. For example, the regional bitstreams may be rectangular based on resource rations and utilization for an associated processing element. However, the regional bitstreams may be any suitable shape, size, or geometry. In addition, the regional bitstreams may be timing-closed and may be translated to one or more locations of the integrated circuit device 12. For example, the regional bitstreams may be pre-compiled for a few locations of the integrated circuit device 12 and may be translated to additional locations through software flows, such as using physical netlist re-write rules, a priori calculation of legal translation rules or steps from device databases, or using engineering change order (ECO) flows. The translations may be performed prior to the user compilation time or may be completed during the user compilation time. The translation may be through software flows, which may not substantially increase the compilation time.

In certain embodiments, constant values may be used through different mechanisms, such as read-only memory (ROM) data in the combined bitstream 104 and/or 106 that may be populated during the user compile time through ECO flows modifying constant literal or register values. Additionally or alternatively, regional configuration bitstreams (e.g., pre-compiled bitstreams, dynamically compiled bitstreams) may correspond to customized or specialized logic implementations to be stitched into the combined bitstream 104 and 106.

Once mapped, the tool may stitch together the mapped regional bitstreams to realize the design on the integrated circuit device 12. As illustrated by the combined bitstreams 104 and 106, the graph nodes 110 may be 1:1 mapped to a respective bitstream 112 and 114. For example, the combined bitstream 104 includes the first graph node 110A mapped to a first bitstream 112A, the second graph node 110B mapped to a second bitstream 112B, the third graph node 110C mapped to a third bitstream 112C, and so on. In certain embodiments, the first graph node 110A may include two individual graph nodes. The tool may map the two graph nodes 110 to one regional bitstream 112 (e.g., many:1). Additionally or alternatively, the tool may map the first graph node 110A to two different regional bitstreams in the library 102 (e.g., 1:many) and stitch together the two regional bitstreams.

The tool may determine a placement of each regional bitstream within the combined bitstream to reduce an amount of unused areas to improve packing efficiency. As illustrated by the combined bitstream 104, the regional bitstreams 112 may be abutting without unused/unassigned areas between them. To this end, the placement of regional bitstreams may be unconstrained with respect to granularity or pitch. As further described with respect to FIG. 6, the pitch may be used for directly abutted regions to align routing ports without routing fixup and to constrain matching physical resource grids. The tool may iteratively determine the placement of the regional bitstreams. For example, routing fixup via bitstream modification may be used for misalignments in ports, even without an allowance region therebetween.

As illustrated by the combined bitstream 106, one or more regional bitstreams 114 (individually referred to as regional bitstreams 114A, 114B, 114C, 114D, 114E, 114F) may not be abutting, thus resulting in an unused area 116. For example, the sixth regional bitstream 114F may be oval, and the combined bitstream 106 may include an unused area 116 between the first regional bitstream 114A, the fourth regional bitstream 114D, the fifth regional bitstream 114E, and the sixth regional bitstream 114E. The unused area 116 may be used for routing connectivity or new logic (e.g., performance counters). For example, the unused area 116 may include debug support circuitry (e.g., trace buffers), performance counter instrumentation, and the like. Additionally or alternatively, the unused area 116 may be power gated (e.g., fully or partially) and may be powered down to reduce power consumption of the integrated circuit device 12. The unused area 116 may be expanded into an adjacent region to provide additional resources to an adjacent bitstream (e.g., combined bitstream). Although the illustrated combined bitstream 114 includes one unused area 116, any suitable number of unused areas 116 may be present within the combined bitstream 114.

The tool may rearrange the combined bitstream 106 to reduce or eliminate the unused area 116. For example, the tool may determine an additional placement of the regional bitstreams 114 based on characteristics of the unused area 116. For example, the tool may adjust the placement of the regional bitstreams 114 (with respect to other regional bitstreams 114) to reduce a size of the unused area 116, reduce a number of unused areas 116, and/or or eliminate the unused area(s) 116. Additionally or alternatively, a size and placement of the regional bitstream 114 may be quantized and/or aligned to a geometric quantum, and connections passing into and/or out of each regional bitstreams 114 may be aligned to a pitch for wire connections to overlap across abutting regions. As such, frequency performance may be improved by adjusting the placement within the combined bitstream 106 and/or routing with the region of the integrated circuit device 12.

The tool may divide a regional bitstream 114 into two or more regional bitstreams 114 to improve placement within the combined bitstream 106. For example, a size of the regional bitstream 114 may be large in comparison to a size of other regional bitstreams 114 being stitched. The tool may break the large regional bitstream 114 into two or more smaller regional bitstreams 114 to reduce a size, a number of unused areas 116 and/or eliminate the unused area 116. Additionally or alternatively, the tool may notify the user of the large regional bitstream 114 and receive user input indicative of cut lines for dividing the large regional bitstream 114. In this way, packing efficiency within the combined bitstream 106 may be improved.

When stitching the regional bitstreams 112 and 114, the tool may also stitch in one or more regional bitstreams to implement one or more device functionality, such as FPGA periphery components, a memory interface, device input/output circuitry, and so on to generate a full device bitstream. In this way, the combined bitstream 104 and 106 may be used to configure the entire integrated circuit device 12. In other embodiments, the combined bitstreams 104 and 106 may be used to configure a portion of the integrated circuit device 12, which may or may not include the device component implementation. For example, the combined bitstream 104 and 106 may configure a partial reconfiguration region of the integrated circuit device 12, which may be configured onto a base design within the partial reconfiguration region. Additionally or alternatively, the tool may stitch together two or more regional bitstreams 112 and 114 to form a larger regional bitstream, a functional component for subsequent bitstream stitching, a customized regional bitstream, and the like. In this way, the bitstream stitching may be hierarchical.

The combined bitstreams 104 and 106 may configure a portion of the integrated circuit device 12, such as one or more partial reconfiguration regions, a portion of a partial region configuration region, one or more programmable logic sectors 74, a portion of a programmable logic sector 74, one or more partitions of the integrated circuit device 12, and so on. Additionally or alternatively, the combined bitstream 104 and 106 may configure a die of the integrated circuit device 12, two or more dies of the integrated circuit device 12, and so on. To this end, the combined bitstreams 104 and 106 may be any suitable shape, size, and/or geometry.

Furthermore, the tool may generate a virtual bitstream representation of the design that may be agnostic to a part number, an FPGA configuration, a speed grade, and the like. The virtual representation may map one graph node 110 to one regional bitstream in the library 102. Additionally or alternatively, the virtual representation may map one graph node 110 to multiple regional bitstreams. Additionally or alternatively, the virtual representation may map multiple graph nodes 110 to one bitstream. As such, the tool may stitch together each bitstream without re-compiling and/or adjusting the contents from the library used in the bitstream.

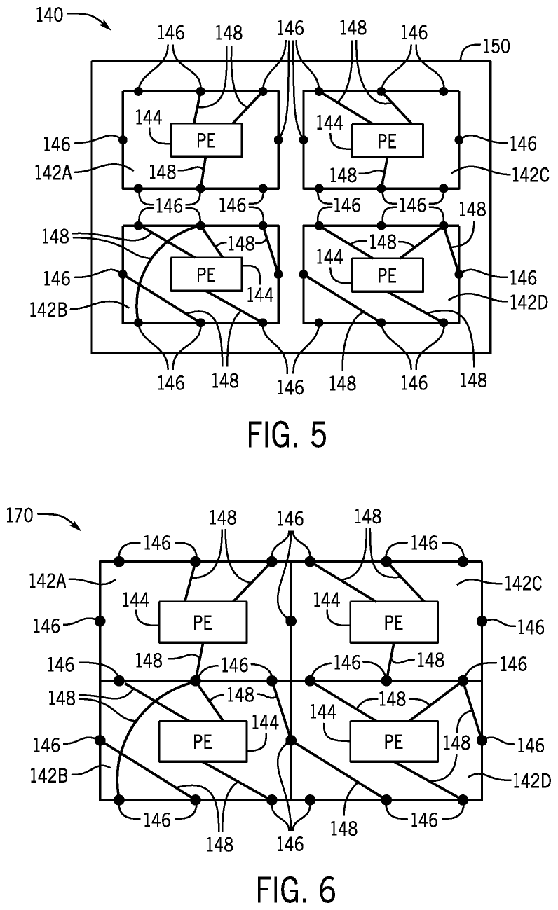

FIGS. 5-7 illustrate a block diagram of a portion 140, 170, and 200 of the integrated circuit device 12 that modularizes regions 142 (individually referred to as a modular regions 142A, 142B, 142C, 142D) to include one or more processing elements (PE) 144 and corresponding routing resources. The regions 142 may include regional bitstreams (e.g., regional bitstreams 112 and 114 described with respect to FIG. 4) that may be pre-compiled, that will be assembled with other regions 142 to implement a design generated (or a portion of a design generated), and/or compiled using the design software 14 and/or the compiler 16. Additionally or alternatively, the regions 142 may include combined bitstreams (e.g., combined bitstreams 104 and 106 described with respect to FIG. 4) that may be assembled with other regions 142 in a hierarchical manner to implement a design. For example, each region 142 may be configured by one combined bitstream, two or more regions 142 may be configured by one combined bitstream, a portion of the region 142 may be configured by one combined bitstream, and so on.

Each region 142 may include the PE 144 used to perform various operations, such as storing data in memory, loading data from memory, arithmetic operations, and the like. Each region 142 may also include one or more nodes 146. The nodes 146 may be set or standardized to align between regions 142 without further tweaking. Additionally or alternatively, the nodes 146 may be substantially aligned within a distance that may be corrected using tweaks within a region 142 to enable the routes 148 within the corresponding regions 142 to be aligned for connectivity.

The nodes 146 may correspond to a modular connection point or inter-block connectivity port that may be used to connect routes 148 across the blocks. Additionally or alternatively, the nodes 146 may correspond to multiple connection points or ports for connection to a corresponding PE 144 within the corresponding region or even different connection points or ports for connection inside of a corresponding PE 144. The routing 148 may correspond to inter-region connectivity between coarse-grained regions 142 to provide connectivity between those regions 142, intra-region connectivity between PEs 144 in a region 142 (when there is more than one PE 144 in a region 142), intra-PE connectivity within the logic circuitry of a PE 144 to establish performance of a function within the PE 144, or a combination of two or more connectivity types. Any of these types of routes 148 may be used in the techniques described above and/or below.

For example, the routing resources may include pre-compiled static routes stored in the library 102 that may be stitched into the combined bitstreams 106 and 108. For example, the routing resources may include a basic set of connections (e.g., default versions of the routes connecting between the nodes 146). The routing resources may be re-routed using an ECO-based or other similar flows. In certain embodiments, the routing resources may be dynamically generated during compilation using fast bounded region compilation (e.g., routing and pipeline only), which may not substantially increase compilation time. As such, routing within and/or between each of the regions 142 may be provided.

With the foregoing in mind, FIG. 5 is a block diagram illustrating the portion 140 of the integrated circuit device 12 including regions 142 coupled by an interposer 150 via the nodes 146. The interposer 150 may include pre-compiled routing resources that may be stitched together with the combined bitstream and/or dynamically generated during the compilation. The interposer 150 may provide connections between the nodes 146 of each region 142. That is, data (e.g., communication packet) from a first region 142A may be transmitted to the interposer 150 via the nodes 146 and be transmitted to nodes 146 of the second region 142B, the third region 142C, and/or the fourth region 142D, which may improve transmission efficiency. To this end, the interposer 150 may include adapters for interface port pitches or geometries that may not align or overlap. The interposer 150 may be any suitable shape or size based on a shape and/or size of the regions 142, a complexity of the routing resources, availability of horizontal and/or vertical wires, connectivity of graph complexity, or through compilation of routing, and so on. Although the illustrated regions 142 are rectangular, the regions 142 may be any suitable shape and/or size based on the PE 144, the routes 148, the functionality, and the like. Additionally or alternatively the shape and/or size of the interposer 150 may be based on the shape and/or size of the regions 142.

FIG. 6 is a block diagram illustrating the portion of 170 of the integrated circuit device 12 that includes regions 142 coupled by the nodes 146. Nodes 146 of each region 142 may align (e.g., overlap) to provide communication between the regions 142 by coupling the edges of the regions 142 together due to their abutting nature. As such, the routing 148 may provide connectivity between each of the regions 142. As illustrated, the nodes 146 of the first region 142A align with nodes 146 of the second region 142B and nodes 146 of the third region 142C. Additionally or alternatively, each of the regions 142 may include a node 146 at a corner of the region 142 such that all four regions 142 overlap. As such, data may be transmitted between each of the regions 142 and/or from a first PE 144 to a second PE 144.

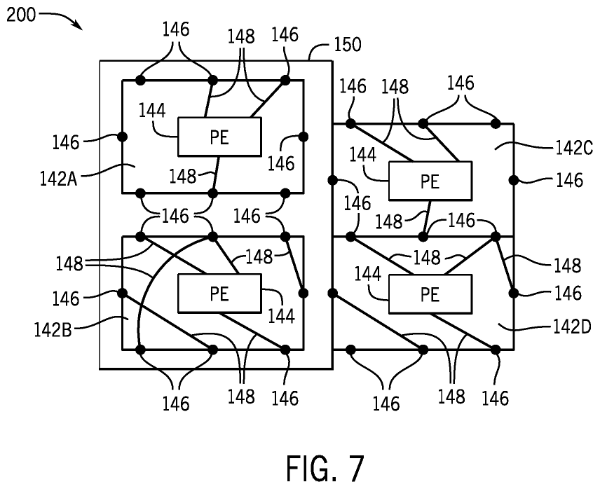

FIG. 7 is a block diagram illustrating the portion 200 of the integrated circuit device 12 that includes regions 142 coupled directly by nodes 146 as described in relation to FIG. 6 and via the interposer 150 as described in relation to FIG. 5. Thus, the techniques described in FIGS. 5 and 6 may both be implemented to connect the regions 142. As illustrated, the first region 142A and the second region 142B are connected together via the interposer 150 while the third region 142C and the fourth region 142D are connected together by aligning respective nodes 146. In addition, the first region 142A and the third region 142C are connected together via the interposer 150 and the second region 142B and the fourth region 142D are connected together via the interposer 150.

The tool may first stitch regions 142 with overlapping nodes 146 together and inject (e.g., stitch) the interposer 150 into the combined bitstream to achieve the design for regions 142 (e.g., bitstreams) that do not abut each other or include overlapping nodes 146. For example, the first region 142A and the second region 142B may not share any overlapping nodes 146. As such, the interposer 150 may connect the first region 142 and the second region 142B. The interposer 150 may be dynamically generated during compilation using fast software flows without substantially increasing the compilation time.

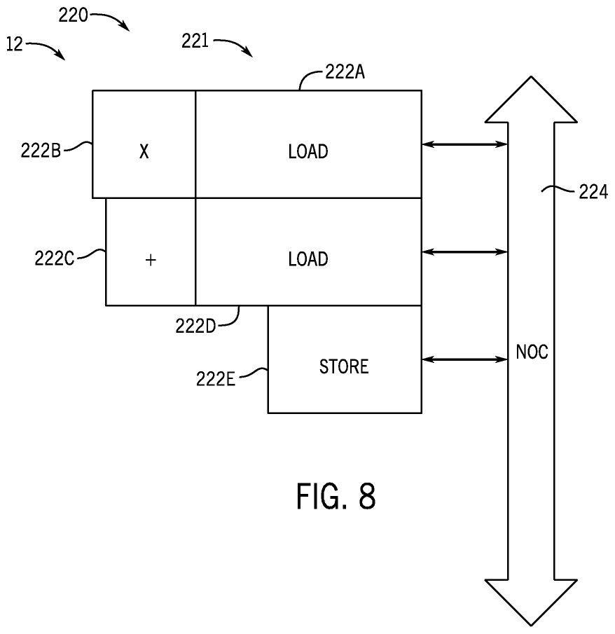

FIG. 8 is a block diagram of a portion 220 of the integrated circuit device 12 implementing a design using a combined bitstream 221 and a network-on-chip (NOC) 224. The NOC 224 may improve data flow within the integrated circuit device 12 and/or placement efficiency of the combined bitstream 221. In addition, the NOC 224 may provide an interface for off-chip memory or other peripheral/transceiver to transmit and/or receive data to and from the combined bitstream 221. The NOC 224 may include any suitable granularity, bandwidth, communication geometry, and so on.

As illustrated, the NOC 224 may be a vertical NOC which may also be a hardened NOC. The NOC 224 may include access points (e.g., NOC bridges, interfaces) at preset locations along the NOC 224 and/or within the integrated circuit device 12 that may be stitched to at least a portion of the combined bitstream. As illustrated, the combined bitstream 221 includes a first regional bitstream 222A including a load functionality, a second regional bitstream 222B including an arithmetic operator and a constant value, a third regional bitstream 222C including an arithmetic operator, a fourth regional bitstream 222D including a load functionality, and a fifth regional bitstream 222E including a store functionality. To improve data flow, the tool may place memory access units (e.g., load functionality, store functionality) adjacent to the NOC 224. For example, the first regional bitstream 222A, the fourth regional bitstream 222D, and the fifth regional bitstream 222E may be stitched to an access point of the NOC 224.

Additionally or alternatively, the NOC 224 may be used as a connectivity mechanism between different regions of the integrated circuit device 12. As such, the combined bitstream 221 may be distributed at various portions of the integrated circuit device 12 and communicate through the NOC 224, which may improve implementation efficiency. For example, a first regional bitstream 222 may be stitched to a first access point located in a first portion of a die and a second regional bitstream 222 may be stitched to a different access point of the NOC 224 that may be in a different portion of the die. As such, the NOC 224 may provide long distance communication between the regional bitstreams 222 without using fine-grained routing. Additionally or alternatively, the NOC 224 may span between the two dies and provide communication between each of the regional configuration bitstreams 222. Decoupling the combined bitstream 221 in this way may also provide spatial translation of bitstreams across die boundaries, such as when the NOC 224 crosses the die boundary. Additionally or alternatively, the regional bitstreams 222 may be translated to additional dies in a disaggregated die or a three-dimensional (3D) stacked die configuration. To this end, the NOC 224 may implement data links (e.g., flow control) between the regional bitstreams on a single die and/or between multiple dies.

Additionally or alternatively, routing circuitry may be stitched into the combined bitstream 221. For example, the library 102 may include pre-compiled routing resources. The tool may stitch in the pre-compiled routing resources to implement the design on one or more dies of the integrated circuit device 12. As such, the routing circuitry may be dynamically generated during compilation using fast bounded region compilation to provide communication to and from the combined bitstream 221.

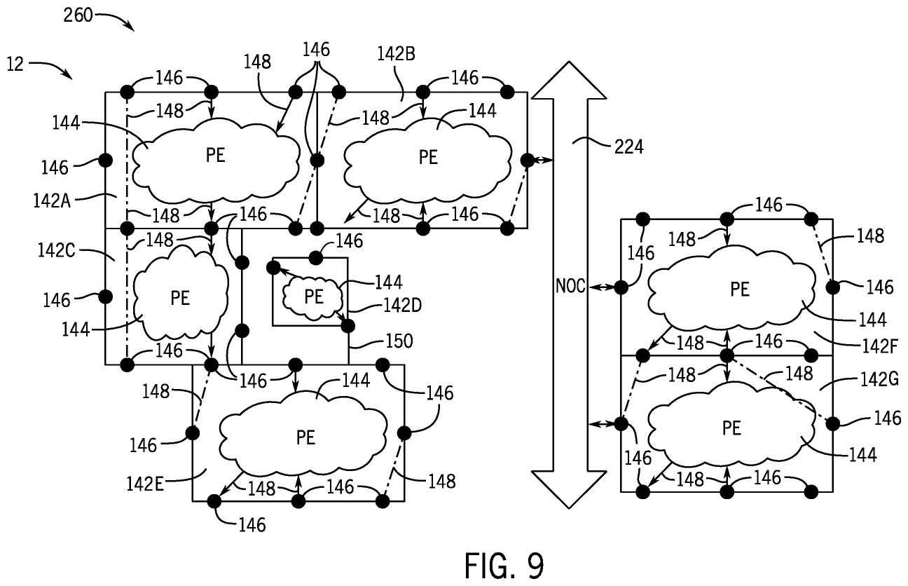

FIG. 9 is a block diagram of a portion 260 of the integrated circuit device 12 implementing a design by bitstream stitching multiple regions 142 and the NOC 224. Any combination of the techniques described in FIGS. 4-8 may be implemented to connect the regions 142. As described herein, each region 142 may include regional bitstreams and/or combined bitstreams of multiple regional bitstreams. The regions 142 may directly abut and connect through overlapping nodes 146. For example, the first region 142A may be directly adjacent to the second region 142B and the third region 142C. In addition, the regions 142 corresponding to memory access units may be adjacent to the NOC 224, which may improve data flow to and from the memory. For example, the second region 142B, the fifth region 142F, and the sixth region 142G may be connected to the NOC 224 for data flow to and from the memory. In addition, the second region 142B may communicate with the fifth region 142F and the sixth region 142G via the NOC 224. The regions 142 may also connect to the interposer 150 that may be pre-compiled and/or dynamically generated. The interposer 150 may be stitched into the combined bitstream to provide adapters when interface port pitches or geometries do not align and/or to implement the design. To this end, a width and/or a height of the interposer 150 may be based on a complexity of the routing, estimated through heuristics (e.g., available wires, graph complexity), or through compilation of routing.

Although the discussion is based on one design, any suitable designs may be decomposed into respective data flow graphs (e.g., kernels) and implemented onto the integrated circuit device 12. For example, multiple designers may independently create a respective design that may be decomposed into a respective data flow graph for configuring the same integrated circuit device 12. Additionally or alternatively, one designer may create multiple designs for configuring the integrated circuit device 12. For example, one combined bitstream may correspond to one kernel, two or more combined bitstreams may be stitched together to form one kernel, or one combined bitstream may correspond to two or more kernels. For example, one combined bitstream may correspond to all data flow graphs. As such, all data flow graphs may be implemented in one device configuration step. Additionally or alternatively, the data flow graphs may correspond to two or more combined configuration bitstreams, which may be implemented individually. In an embodiment, one kernel may be implemented while other designs may be executing other kernels for multi-tenancy or performance optimization of task graph scheduling or execution. For example, placement and routing between combined bitstreams corresponding to multiple data flow graphs may be swapped to improve implementation efficiency. The routing resources may be stitched into the combined bitstreams to decrease a number and/or a size of unused areas on the integrated circuit device 12.

Additionally or alternatively, one kernel may be reconfigured while one or more additional kernels are executing on the integrated circuit device 12. For example, coarse-grained function units corresponding to the combined bitstreams may be decoupled at one or more cut lines by the nature of the coarse-grained assembly flow. Control and buffering inserted at the cut lines by partial reconfiguration or earlier compilations may allow arbitrarily sized kernels with phased execution to fit on the integrated circuit device 12, even if all elements of the kernel may not fit at the same time. In other words, the design may be too large to be implemented in the available regions of the integrated circuit device 12 all at one time. As such, a first portion of the design (e.g., at a cut line) may be implemented and executed on the integrated circuit device 12, then a second portion of the design may be implemented and executed. After a partial reconfiguration, the second portion of the design may be implemented in some of the same regions that implemented the first portion of the design before the partial reconfiguration. As such, the integrated circuit device 12 may be dynamically reconfigured to perform different parts of an operation at different times.

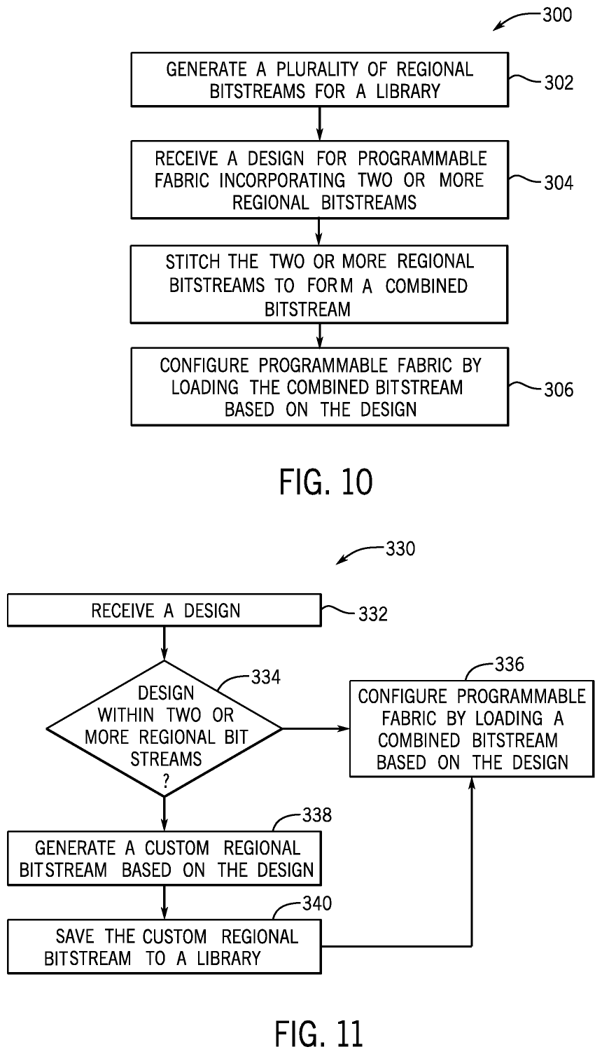

FIG. 10 is a flowchart of a method 300 for implementing a design into the integrated circuit device 12 using bitstream stitching. A user may develop a design for the integrated circuit device 12. For example, the user may use the design software 14 to develop the design. A tool within the design software 14 may decompose the design into two or more regional bitstreams, bitstream stitch the two or more regional bitstreams into a combined bitstream, and implement the combined bitstream to realize the design.

With the foregoing in mind, at block 302, a plurality of regional bitstreams may be generated for a library 102. Accessing the library 102 may include generating the regional bitstreams using a processor and/or accessing entries in storage that detail the regional bitstreams. In certain embodiments, the regional bitstreams may be generated and pre-compiled in parallel with one or more additional regional bitstreams. For example, accessing the entries may include accessing/retrieving the regional bitstreams via a website, cloud, from local memory, and/or any other suitable access mechanisms from local and/or remote depositories. The library 102 may include regional bitstreams generated by, for, and/or using the design software 14 or may be received from others (e.g., other user designs from other users). As previously noted, to decrease compilation time, the regional bitstreams may be pre-compiled based on a location, a data type, an operation, and the like. As discussed above, certain regional bitstreams may be pre-generated prior and made available (e.g., via a website or web address) to the designer. Additionally or alternatively, the user may create one or more functions specific to the designer that may be compiled at one time and stored in the library 102 as a pre-compiled regional bitstream to be used later.

At block 304, a design for a programmable fabric incorporating two or more regional bitstreams may be received. For example, the design software 14 may receive a design to be implemented onto the integrated circuit device 12. The design may be bounded into data flow graph 100 including one or more graph nodes 110. The graph nodes 110 may be mapped to one or more regional bitstreams stored in the library 102.

At block 306, two or more regional bitstreams may be stitched to form a combined bitstream. The tool may stitch the regional bitstreams to form the combined bitstream for implementing at least a portion of the design. For example, the tool may stitch together two or more regional bitstreams to form a larger bitstream that corresponds to a portion of the design by connecting together edge connections between the two or more regional bitstreams and/or other surrounding circuitry used to implement other parts of the design. Indeed, the larger regional bitstream may be stitched to additional regional bitstreams using a hierarchical architecture to form the combined bitstream. Additionally or alternatively, the tool may stitch together two or more regional bitstreams to form the combined configuration bitstream for the entire integrated circuit device 12. As discussed herein, the tool may stitch together two or more regional bitstreams by directly abutting the regions 142, connecting the regions 142 via an interposer 150, connecting the regions 142 via a NOC 224, or any combination thereof.

At block 308, the programmable fabric of the integrated circuit device 12 may be configured by loading the combined bitstream based on the design. The combined bitstream may configure all or a portion of the integrated circuit device 12. For example, the combined bitstream may be used to configure all of the integrated circuit device 12. Additionally or alternatively, the combined bitstream may configure a portion of the integrated circuit device 12, such as one or more sectors, a sub-sector, one or more partitions, a sub-partition, one or more partial reconfiguration regions, and so on. The combined bitstream may be translated during the configuration of the integrated circuit device 12 using fast software flows. As such, the design may be realized.

The method 300 includes various steps represented by blocks. Although the flowchart illustrates the steps in a certain sequence, it should be understood that the steps may be performed in any suitable order and certain steps may be carried out simultaneously, where appropriate.

FIG. 11 is a flowchart of a method 330 for configuring the integrated circuit device 12 using the combined bitstream. As discussed herein, the library 102 may include pre-compiled regional bitstreams that may be stitched together to form a combined bitstream. To reduce a number of regional bitstreams within the library 102, the regional bitstreams may be compiled for one or few locations on the integrated circuit device 12 and then translated to additional placements through software flows rather than multiple instances stored with a different instance used for each location. Additionally or alternatively, the regional bitstreams may be one or a set of base regional bitstreams that may be pre-compiled using a subset of device resources that may include improved transability (e.g., isomorphic, mappable across the translation). The translation may be based on physical mapping of the regional bitstream and/or device translation information. For example, original compilation may be compiled to a subset of resources that may be fully or partially translatable to other locations without involving fixup.

Additionally or alternatively, translation may be on a non-final netlist format for a virtual bitstream. In other words, the virtual bitstream may include a netlist or a proxy for the integrated circuit device 12 configuration and may provide improved translation by maintaining additional information and/or structure for the configuration. For example, cross-device translations may be improved using the virtual bitstream.

With the foregoing in mind, the design may be received at block 332. As discussed herein, the tool may decompose the design into a data flow graph 100 and map each graph node 110 to one or more regional bitstreams stored in the library 102 to create the combined bitstream.

At block 334, a determination of whether the design uses two or more regional bitstreams is made. The tool may determine whether the graph nodes 110 map to a regional bitstream and/or a set of a set of regional bitstreams in the library 102. For example, the tool may compare the operations of the graph nodes 110 to the operations of the regional bitstreams to determine whether there is an appropriate mapping. If so, the tool may map the graph node(s) 110 to two or more regional bitstreams and stitch the two or more regional bitstreams together to form the combined bitstream prior to compilation. In addition, the tool may determine the placement and routing of the combined bitstream on the integrated circuit device 12. For example, the tool may stitch in routing resources (e.g., interposer, nodes) to provide communication between the regional bitstreams. Additionally or alternatively, the tool may determine placement of the combined bitstream adjacent to NOC 224 within the integrated circuit device 12. Furthermore, the tool may generate a virtual bitstream for realizing the design.

If the design may be implemented using the regional bitstreams, then at block 336, a combined bitstream may be implemented on all or a portion of the integrated circuit device 12 to realize the design. After compilation, the combined bitstreams may be implemented on the integrated circuit device 12. Alternatively, the tool may implement the virtual bitstream to realize the design.

If the design may not be implemented using the regional bitstreams, then at block 338, a custom regional bitstream may be generated. For example, all or a portion of the design may not be mapped to one or more regional bitstreams stored in the library 102. The tool may generate the custom regional bitstream based on the design and/or a respective graph node 110. In an embodiment, a portion of the design may not be mapped, which may be generated as a custom regional bitstream during compilation. If only a portion of the design may not be mapped to pre-compiled bitstreams, the compilation time may still be reduced in comparison to compiling the whole design. As such, the tool may implement the design using a coarse-grained operation for the combined bitstream and a fine-grained operation for the custom regional bitstream. In other embodiments, all of the design may not be mapped and the tool may implement the design using fine-grained operation compiling all of the design. The tool may then save the compiled design as a custom regional bitstream. As such, subsequent compilations integrating the design may be performed without re-compilation.

At block 340, the custom regional bitstream may be saved to the library 102. Once compiled, a stored compilation does not need to be re-compiled, thereby reducing subsequent compilation time. The custom regional bitstream may be saved along with a location on the integrated circuit device 12, a connection or pitch, a routing solution, and so on. For subsequent implementations, the tool may place the custom regional bitstream at the same location on the integrated circuit device 12 and determine placement for additional regional bitstreams around the custom regional bitstream. Additionally or alternatively, the custom regional bitstream may be translated using software flows and the tool may determine placement based on the design. In some embodiments, the saving of the custom regional bitstream may be optional. For example, if the custom regional bitstream is unlikely to be used again, the tool may receive an indication that the compiled custom regional bitstream is not to be saved for future use and skip such storage.

The method 330 includes various steps represented by blocks. Although the flow chart illustrates the steps in a certain sequence, it should be understood that the steps may be performed in any suitable order and certain steps may be carried out simultaneously, where appropriate. Further, certain steps or portions of the method 330 may be performed by separate systems or devices.

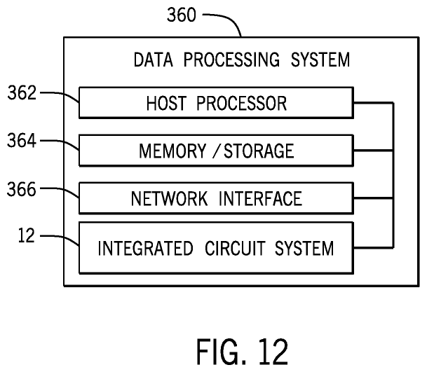

Bearing the foregoing in mind, the integrated circuit device 12 may be a component included in a data processing system, such as a data processing system 360, shown in FIG. 12. The data processing system 360 may include the integrated circuit device 12 (e.g., a programmable logic device), a host processor 362 (e.g., a processor), memory and/or storage circuitry 364, and a network interface 366. The data processing system 360 may include more or fewer components (e.g., electronic display, user interface structures, application specific integrated circuits (ASICs)). Moreover, any of the circuit components depicted in FIG. 12 may include integrated circuits (e.g., integrated circuit device 12). The host processor 362 may include any of the foregoing processors that may manage a data processing request for the data processing system 360 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 364 may include random access memory (RAM), read-only memory (ROM), one or more hard drives, flash memory, or the like. The memory and/or storage circuitry 364 may hold data to be processed by the data processing system 360. In some cases, the memory and/or storage circuitry 364 may also store configuration programs (bitstreams) for programming the integrated circuit device 12. The network interface 368 may allow the data processing system 360 to communicate with other electronic devices. The data processing system 360 may include several different packages or may be contained within a single package on a single package substrate. For example, components of the data processing system 360 may be located on several different packages at one location (e.g., a data center) or multiple locations. Additionally or alternatively, components of the data processing system 360 may be located in separate geographic locations or areas, such as cities, states, or countries.

In one example, the data processing system 360 may be part of a data center that processes a variety of different requests. For instance, the data processing system 360 may receive a data processing request via the network interface 368 to perform encryption, decryption, machine learning, video processing, voice recognition, image recognition, data compression, database search ranking, bioinformatics, network security pattern identification, spatial navigation, digital signal processing, or some other specialized task.

The above discussion has been provided by way of example. Indeed, the embodiments of this disclosure may be susceptible to a variety of modifications and alternative forms. Indeed, many other suitable forms of high-capacity integrated circuits can be manufactured according to the techniques outlined above. For example, the high-capacity integrated circuit may be configured using the combined bitstreams. The combined bitstreams may be stitched using two or more regional bitstreams that may be pre-compiled to reduce the compilation time. In this way, the high-capacity integrated circuit may be configured or reconfigured using less time. Moreover, the high-capacity integrated circuit device may include networks-on-chip and/or interposers for data transfer between regions and/or dies to improve both implementation efficiency and throughput.

While the embodiments set forth in the present disclosure may be susceptible to various modifications and alternative forms, specific embodiments have been shown by way of example in the drawings and have been described in detail herein. However, it should be understood that the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### Example Embodiments

EXAMPLE EMBODIMENT 1. A tangible, non-transitory, and computer-readable medium, storing instructions thereon that when executed, are to cause a processor to receive a design to be implemented onto a programmable fabric of an integrated circuit device, determine that the design is implementable using two or more regional bitstreams from a library comprising a plurality of regional bitstreams, and stitch together the two or more regional bitstreams to generate a combined bitstream, wherein the two or more regional bitstreams are compiled at a different time than other portions of the design.
EXAMPLE EMBODIMENT 2. The tangible, non-transitory, and computer-readable medium of example embodiment 1, wherein stitching together the two or more regional bitstreams comprises determining that at least one node of a first regional bitstream of the two or more regional bitstreams overlaps with at least one node of a second regional bitstream of the two or more regional bitstreams and stitching the first regional bitstream and the second regional bitstream together at the at least one overlapping node.
EXAMPLE EMBODIMENT 3. The tangible, non-transitory, and computer-readable medium of example embodiment 1, wherein stitching together the two or more regional bitstreams comprises determining routing through an interposer between a first regional bitstream of the two or more regional bitstreams and a second regional bitstream of the two or more regional bitstreams in response to determining the first regional bitstream does not overlap with the second regional bitstream.
EXAMPLE EMBODIMENT 4. The tangible, non-transitory, and computer-readable medium of example embodiment 1, wherein stitching together the two or more regional bitstreams comprises stitching a first regional bitstream of the two or more regional bitstreams to a first access point of a network-on-chip and stitching a second regional bitstream of the two or more regional bitstreams to a second access point of the network-on-chip.
EXAMPLE EMBODIMENT 5. The tangible, non-transitory, and computer-readable medium of example embodiment 1, wherein the instructions, when executed, are to cause the processor to determine that the combined bitstream comprises an unused area and power down a region of the integrated circuit device configured by the unused area.
EXAMPLE EMBODIMENT 6. The tangible, non-transitory, and computer-readable medium of example embodiment 1, wherein the instructions, when executed, are to cause the processor to receive a second design to implement onto the programmable fabric of the integrated circuit device, determine that a first portion of the second design is not implementable using any regional bitstreams from the library and a second portion of the second design is implementable using two or more additional regional bitstreams from the library, compile the first portion of the second design to generate a custom regional bitstream, and stitch the two or more additional regional bitstreams together with the custom regional bitstream to form an additional combined bitstream.
EXAMPLE EMBODIMENT 7. The tangible, non-transitory, and computer-readable medium of example embodiment 6, wherein the instructions, when executed, are to cause the processor to store the custom regional bitstream in the library and store a location of the integrated circuit device corresponding to compiling the custom regional bitstream.
EXAMPLE EMBODIMENT 8. The tangible, non-transitory, and computer-readable medium of example embodiment 7, wherein the instructions, when executed, are to cause the processor to receive a third design to be implemented onto the programmable fabric, determine that the third design is implementable using the custom regional bitstream and at least one regional bitstream, and stitch together the custom regional bitstream and the at least one regional bitstream to generate a third combined bitstream.
EXAMPLE EMBODIMENT 9. The tangible, non-transitory, and computer-readable medium of example embodiment 1, wherein determining that the design is implementable using the two or more regional bitstreams comprise decomposing the design into a compiler data flow graph comprising one or more graph nodes and mapping the one or more graph nodes to one or more regional bitstreams of the plurality of regional bitstreams.
EXAMPLE EMBODIMENT 10. A method, comprising receiving, via processing circuitry, a design to implement on an integrated circuit device, mapping, via the processing circuitry, the design to two or more regional bitstreams stored in a library, wherein the two or more regional bitstreams are pre-compiled before compilation of other parts of the design. The method also comprises stitching, via the processing circuitry, together the two or more regional bitstreams mapped to the design to generate a combined bitstream.
EXAMPLE EMBODIMENT 11. The method of example embodiment 10, wherein the two or more regional bitstreams is to cause a programmable fabric of the integrated circuit device to implement a memory interface or an input/output interface.
EXAMPLE EMBODIMENT 12. The method of example embodiment 10, wherein stitching together the two or more regional bitstreams comprises determining placement for a first regional bitstream of the two or more regional bitstreams adjacent to a first access point of a network-on-chip and determining placement for a second regional bitstream of the two or more regional bitstreams adjacent to a second access point of the network-on-chip, wherein the first regional bitstream and the second regional bitstream are to communicate via the network-on-chip.
EXAMPLE EMBODIMENT 13. The method of example embodiment 10, wherein mapping, via the processing circuitry, the design to the two or more regional bitstreams stored in the library comprises generating a data flow based on the design, determining whether nodes of the data flow match the two or more regional bitstreams stored the library, determining one or more respective regions of the integrated circuit device for implementing the two or more regional bitstreams, and determining a routing between the two or more regional bitstreams based on the design.
EXAMPLE EMBODIMENT 14. The method of example embodiment 13, wherein determining the routing between the two or more regional bitstreams comprises determining that a pitch of a first regional bitstream of the two or more regional bitstreams aligns with a pitch of a second regional bitstream of the two or more regional bitstreams.
EXAMPLE EMBODIMENT 15. An electronic device comprising memory storing a plurality of regional bitstreams and instructions, and a processor, that when executing the instructions, is to receive a design for a programmable fabric of an integrated circuit device, determine that the design uses at least two regional bitstreams that have been compile before the design has been received, and stitch together the at least two regional bitstreams to generate a combined bitstream.
EXAMPLE EMBODIMENT 16. The integrated circuit device of example embodiment 15, wherein stitching together the at least two regional bitstreams comprises determining a first placement of a first regional bitstream of the at least two regional bitstreams adjacent to a first access point of a network-on-chip, determining a second placement of a second regional bitstream of the at least two regional bitstreams adjacent to a second access point of the network-on-chip, and stitching the first regional bitstream to the first access point and the second regional bitstream to the second access point.
EXAMPLE EMBODIMENT 17. The integrated circuit device of example embodiment 16, wherein a size or a shape of the first regional bitstream is different from a size or a shape of the second regional bitstream.
EXAMPLE EMBODIMENT 18. The integrated circuit device of example embodiment 16, wherein the network-on-chip spans from a first die of the integrated circuit device to a second die of the integrated circuit device, and wherein the first regional bitstream is to configure a first programmable fabric of the first die and the second regional bitstream is to configure a second programmable fabric of the second die.
EXAMPLE EMBODIMENT 19. The integrated circuit device of example embodiment 15, wherein configuring the programmable fabric using the combined bitstream comprises determining a region of the programmable fabric not configured by the combined bitstream and powering down the region.
EXAMPLE EMBODIMENT 20. The integrated circuit device of example embodiment 15, wherein configuring the programmable fabric using the combined bitstream comprises determining a size of the combined bitstream is larger than a threshold, and dividing the combined bitstream into two or more separated bitstreams.

What is claimed is:

1. A tangible, non-transitory, and computer-readable medium, storing instructions thereon that when executed, are to cause a processor to:
receive a design to be implemented onto a programmable fabric of an integrated circuit device;
determine that the design is implementable using two or more regional bitstreams from a library comprising a plurality of regional bitstreams; and
stitch together the two or more regional bitstreams to generate a combined bitstream, wherein the two or more regional bitstreams are compiled at a different time than other portions of the design.

2. The tangible, non-transitory, and computer-readable medium of claim 1, wherein stitching together the two or more regional bitstreams comprises:
determining that at least one node of a first regional bitstream of the two or more regional bitstreams overlaps with at least one node of a second regional bitstream of the two or more regional bitstreams; and
stitching the first regional bitstream and the second regional bitstream together at the at least one overlapping node.

3. The tangible, non-transitory, and computer-readable medium of claim 1, wherein stitching together the two or more regional bitstreams comprises:
determining routing through an interposer between a first regional bitstream of the two or more regional bitstreams and a second regional bitstream of the two or more regional bitstreams in response to determining the first regional bitstream does not overlap with the second regional bitstream.

4. The tangible, non-transitory, and computer-readable medium of claim 1, wherein stitching together the two or more regional bitstreams comprises:
stitching a first regional bitstream of the two or more regional bitstreams to a first access point of a network-on-chip; and
stitching a second regional bitstream of the two or more regional bitstreams to a second access point of the network-on-chip.

5. The tangible, non-transitory, and computer-readable medium of claim 1, wherein the instructions, when executed, are to cause the processor to:
determine that the combined bitstream comprises an unused area; and
power down a region of the integrated circuit device configured by the unused area.

6. The tangible, non-transitory, and computer-readable medium of claim 1, wherein the instructions, when executed, are to cause the processor to:
receive a second design to implement onto the programmable fabric of the integrated circuit device;
determine that a first portion of the second design is not implementable using any regional bitstreams from the library and a second portion of the second design is implementable using two or more additional regional bitstreams from the library;
compile the first portion of the second design to generate a custom regional bitstream; and
stitch the two or more additional regional bitstreams together with the custom regional bitstream to form an additional combined bitstream.

7. The tangible, non-transitory, and computer-readable medium of claim 6, wherein the instructions, when executed, are to cause the processor to:
store the custom regional bitstream in the library; and
store a location of the integrated circuit device corresponding to compiling the custom regional bitstream.

8. The tangible, non-transitory, and computer-readable medium of claim 7, wherein the instructions, when executed, are to cause the processor to:
receive a third design to be implemented onto the programmable fabric;
determine that the third design is implementable using the custom regional bitstream and at least one regional bitstream; and
stitch together the custom regional bitstream and the at least one regional bitstream to generate a third combined bitstream.

9. The tangible, non-transitory, and computer-readable medium of claim 1, wherein determining that the design is implementable using the two or more regional bitstreams comprise:
decomposing the design into a compiler data flow graph comprising one or more graph nodes; and
mapping the one or more graph nodes to one or more regional bitstreams of the plurality of regional bitstreams.

10. A method, comprising:
receiving, via processing circuitry, a design to implement on an integrated circuit device;
mapping, via the processing circuitry, the design to two or more regional bitstreams stored in a library, wherein the two or more regional bitstreams are pre-compiled before compilation of other parts of the design; and
stitching, via the processing circuitry, together the two or more regional bitstreams mapped to the design to generate a combined bitstream.

11. The method of claim 10, wherein the two or more regional bitstreams is to cause a programmable fabric of the integrated circuit device to implement a memory interface or an input/output interface.

12. The method of claim 10, wherein stitching together the two or more regional bitstreams comprises:
determining placement for a first regional bitstream of the two or more regional bitstreams adjacent to a first access point of a network-on-chip; and
determining placement for a second regional bitstream of the two or more regional bitstreams adjacent to a second access point of the network-on-chip, wherein the first regional bitstream and the second regional bitstream are to communicate via the network-on-chip.

13. The method of claim 10, wherein mapping, via the processing circuitry, the design to the two or more regional bitstreams stored in the library comprises:
generating a data flow based on the design;
determining whether nodes of the data flow match the two or more regional bitstreams stored the library;
determining one or more respective regions of the integrated circuit device for implementing the two or more regional bitstreams; and
determining a routing between the two or more regional bitstreams based on the design.

14. The method of claim 13, wherein determining the routing between the two or more regional bitstreams comprises:
determining that a pitch of a first regional bitstream of the two or more regional bitstreams aligns with a pitch of a second regional bitstream of the two or more regional bitstreams.

15. An electronic device, comprising:
memory storing a plurality of regional bitstreams and instructions; and
a processor, that when executing the instructions, is to:
receive a design for a programmable fabric of an integrated circuit device;
determine that the design uses at least two regional bitstreams that have been compile before the design has been received; and
stitch together the at least two regional bitstreams to generate a combined bitstream.

16. The integrated circuit device of claim 15, wherein stitching together the at least two regional bitstreams comprises:
determining a first placement of a first regional bitstream of the at least two regional bitstreams adjacent to a first access point of a network-on-chip;
determining a second placement of a second regional bitstream of the at least two regional bitstreams adjacent to a second access point of the network-on-chip; and
stitching the first regional bitstream to the first access point and the second regional bitstream to the second access point.

17. The integrated circuit device of claim 16, wherein a size or a shape of the first regional bitstream is different from a size or a shape of the second regional bitstream.

18. The integrated circuit device of claim 16, wherein the network-on-chip spans from a first die of the integrated circuit device to a second die of the integrated circuit device, and wherein the first regional bitstream is to configure a first programmable fabric of the first die and the second regional bitstream is to configure a second programmable fabric of the second die.

19. The integrated circuit device of claim 15, wherein configuring the programmable fabric using the combined bitstream comprises:
determining a region of the programmable fabric not configured by the combined bitstream; and
powering down the region.

20. The integrated circuit device of claim 15, wherein configuring the programmable fabric using the combined bitstream comprises:
determining a size of the combined bitstream is larger than a threshold; and
dividing the combined bitstream into two or more separated bitstreams.
